(19) United States
(12) Patent Application Publication
(10) Pub. No.: US 2005/0065691 A1
(43) Pub. Date: Mar. 24, 2005

(54) Torque control method for an internal combustion engine

(76) Inventor: Byoung Hoon Cho, Yongin-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,908

(22) Filed: Dec. 29, 2003

(30) Foreign Application Priority Data
Sep. 9, 2003 (KR) 10-2003-0063079

(51) Int. Cl. G06F 7/00

(52) U.S. Cl. 701/54; 701/51; 701/103

(57) ABSTRACT

A torque control method for an internal combustion engine for computing a required torque and controlling a throttle motor on the basis of the required torque includes computing a first required torque on the basis of a depression amount of an acceleration pedal and an engine speed, and computing a second required torque by multiplying an output value of a gradient limit function by an output value of a time delay function. The output value of the gradient limit function is determined on the basis of the first required torque, an acceleration pedal depression amount, an engine speed, and a shift range. The output value of the time delay function is determined on the basis of the shift range.

### CROSS-REFERENCE TO RELATED APPLICATIONS

This application claims priority of Korean Application No. 10-2003-0063079, filed on Sep. 9, 2003, the disclosure of which is incorporated fully herein by reference.

### FIELD OF THE INVENTION

The present invention relates to a torque control method for an internal combustion engine, and, more particularly, to a torque control method for an internal combustion engine utilizing ETC (Electric Throttle Control).

### BACKGROUND OF THE INVENTION

Generally, when the torque control of the internal combustion engine is executed in an ETC (Electronic Throttle Control) manner, a required torque of the engine is determined on the basis of the data transferred from an ECU (Engine Control Unit), and the ECU controls the fuel injection amount and throttle opening on the basis of the determined required torque.

The required torque of the engine can be divided into a first required torque and a second required torque that is computed from the first required torque by modification. The first required torque is determined by applying a gear shift position, a depression amount of the acceleration pedal, and the engine speed to a look-up table such that the driver's intention is correctly reflected to the first required torque. However, in order to prevent a shock caused by an abrupt throttle opening and to achieve smooth acceleration, the first required torque is modified such that a second required torque is computed.

FIG. 7 is a graph showing the first required torque and the second required torque according to a conventional torque control method of the internal combustion engine, when the modification of the first required toque is executed on the basis of a gradient limit of the required torque and the torque filter. As shown in FIG. 7, when the gradient of the dashed line representative of the first required torque is higher than a predetermined value, the first required torque is modified to the predetermined value and time-delayed by the torque filter. The second required torque that is modified from the first required torque is represented by the solid line in FIG. 7. Accordingly, a shock caused by an abrupt throttle opening is prevented and a smooth acceleration feel can be achieved.

However, according to the conventional torque control method, if the gradient of the dashed line representative of the first required torque is higher than a predetermined value is the first torque modified to have a constant gradient of the predetermined value, such that the driver's intention is not correctly reflected onto the torque control process.

Furthermore, the torque filter for time-delaying the first required torque is applied regardless of shift range such that acceleration performance at a high shift range compared with an acceleration performance at low shift range is deteriorated.

### SUMMARY OF THE INVENTION

An exemplary torque control method for an internal combustion engine for computing a required torque and controlling a throttle motor on the basis of the required torque according to an embodiment of the present invention includes computing a first required torque on the basis of a depression amount of the acceleration pedal and an engine speed, and computing a second required torque by multiplying an output value of a gradient limit function by an output value of a time delay function, wherein the output value of the gradient limit function is determined on the basis of the first required torque, an acceleration pedal depression amount, an engine speed, and a shift range, and wherein the output value of the time delay function is determined on the basis of the shift range.

In a further embodiment, the gradient limit function is defined by multiplying a basic gradient limit function of which the output value is determined on the basis of the first required torque, the engine speed, and the shift range, by a weight function of which the output value is determined on the basis of the acceleration pedal depression amount and the shift range.

Preferably, the output value of the weight function is proportional to the acceleration pedal depression amount.

Preferably, the time delay function is defined as a one-dimensional time delay function, and an output value of the time delay function is determined on the basis of the shift range.

Preferably, the output value of the time delay function is proportional to the shift range.

Preferably, the output values of the gradient limit function, the weight function, and the time delay function are determined from a plurality of predetermined look-up tables.

Embodiments of the present invention thus provide a torque control method having non-limiting advantages of correctly reflecting a driver's intention onto the modified required torque.

### BRIEF DESCRIPTION OF THE DRAWINGS

FIG. 1 is a schematic diagram of torque control system of an embodiment of the present invention according to this invention;

FIG. 2 is a block diagram of the ECU of FIG. 1;

FIG. 3 is a flow diagram illustrating a torque control method according to an embodiment of the present invention;

FIG. 4 is a graph showing a first look-up table used for computing the first required torque according to an embodiment of the present invention;

FIG. 5A is a graph showing a second look up-table used for computing the first modified required torque;

FIG. 5B is a graph showing a third look-up table used for computing the weighting for the second modified required torque;

FIG. 6 is a graph showing a fourth look-up table used for computing the second required torque according to an embodiment of the present invention; and

FIG. 7 is a graph showing the first required torque and the second required torque according to a conventional torque control method of the internal combustion engine.

### DETAILED DESCRIPTION OF THE PREFERRED EMBODIMENTS

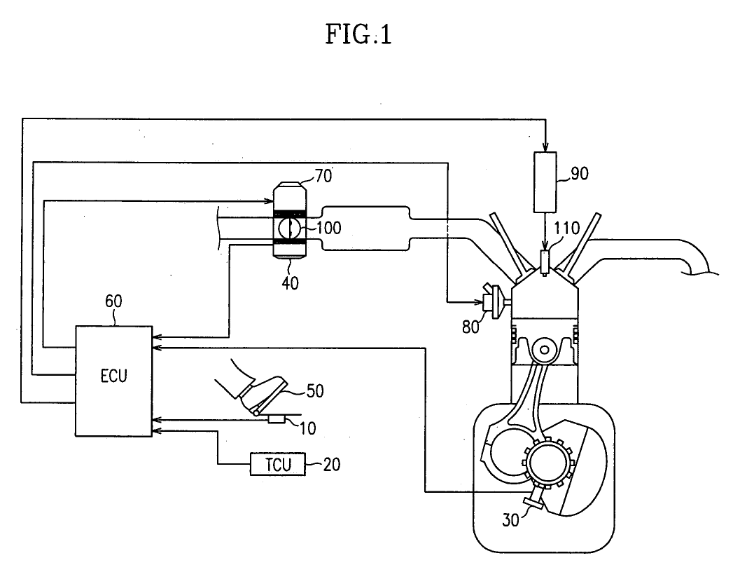

As shown in FIG. 1, a torque control system according to an embodiment of the present invention includes a plurality of sensors and an ECU. A crank position sensor 30 outputs pulse signals, each of which corresponds to one of teeth located in the vicinity of a signal rotor which is coupled to the crankshaft, and the ECU computes the signals from the crank position sensor 30. An acceleration pedal 50 is located in the passenger compartment. When the driver steps on the acceleration pedal 50, the depression amount of the acceleration pedal 50 is detected by an acceleration pedal position sensor 10. A throttle valve 100 is located in an upstream side of the intake port, and the throttle valve 100 adjusts the cross-sectional area of an intake passage by the throttle motor 70, which is actuated in accordance with the signal of the acceleration pedal position sensor 10. A throttle position sensor 40 detects the cross-sectional area of the intake passage which determines the amount of air introduced into each combustion chamber. A fuel injector 80 supplies fuel to each of the combustion chambers. An igniter 90 adjusts the ignition timing of a spark plug 110, and the spark plug 110 ignites an air-fuel mixture in the combustion chamber.

A TCU 20 controls a transmission, and transfers a signal corresponding to a shift range to an ECU 60. TCU 20 may comprise an approximately programmed processor and associated hardware as will be understood by persons skilled in the art.

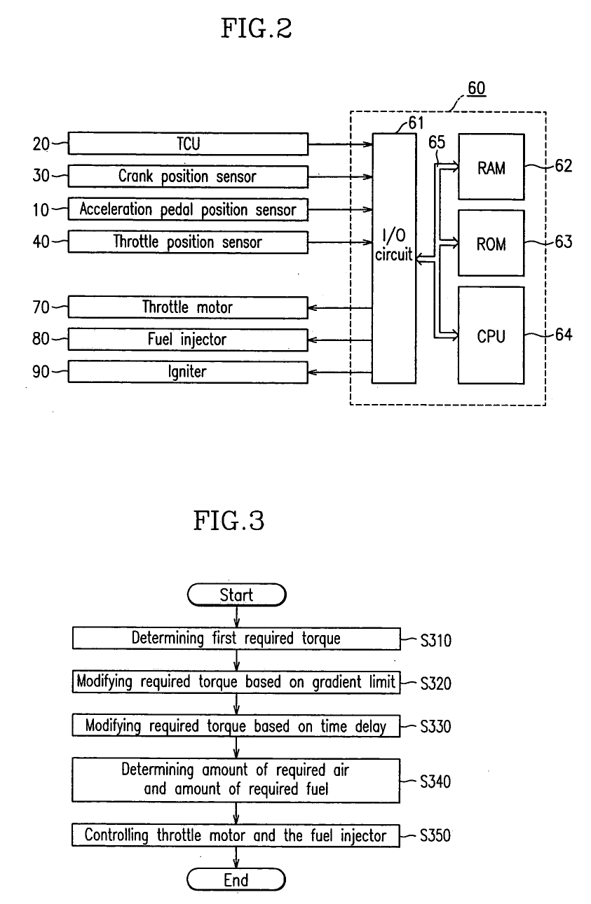

The ECU 60 according to the present invention will now be described with reference to FIG. 2. The ECU 60 controls the throttle motor 70, the injector 80, and the igniter 90 on the basis of the signals from the acceleration pedal position sensor 10, the crank position sensor 30, the throttle position sensor 40, and the TCU 20.

The ECU 60 is a logic circuit including a RAM 62, a ROM 63, and a CPU 64. The ROM 63 stores various control programs and look-up tables used in the programs, the CPU 64 executes various computations on the basis of the programs and the look-up tables stored in the ROM 63, and the RAM 62 temporarily stores the results of the computations and data from the various sensors. The ROM 63, the RAM 62, and the CPU 64 are connected to one another by a bus 65, and the bus 65 also connects the ROM 63, the RAM 62, and the CPU 64 to the I/O circuit 61.

The I/O circuit 61 is connected to the various sensors 10, 30, 40, the TCU 20, the throttle motor 70, the injector 80, and the igniter 90.

As shown in FIG. 3, the ECU 60 computes a first required torque by applying the shift range from the TCU 20, the depression amount of the acceleration pedal 50 from the acceleration pedal position sensor 10, and the engine speed from the crank position sensor 10 to a predetermined look-up table stored in the ROM 63 at step S310.

At step S320, the first required torque is inputted to a gradient limit function defined by multiplying a basic gradient limit function, of which the output value is determined on the basis of the first required torque, the engine speed, and the shift range, by a weight function, of which the output value is determined on the basis of the acceleration pedal depression amount and the shift range.

Specifically, when the gradient of the first required torque with respect to time is more than a predetermined value, the first modified torque is outputted by utilizing a predetermined look-up table representative of the basic gradient limit function. The first modified required torque is multiplied by a weighting outputted from a predetermined look-up table representative of the weight function.

At step S330, the second modified torque is inputted to a torque filter defined as a one-dimensional time delay function for modifying such that a second required torque is outputted by utilizing predetermined look-up tables representative of the torque filter at step S330.

At step S340, the ECU 60 computes the amount of required air to be introduced and the amount of required fuel to be injected on the basis of the second required torque. At step S350, the throttle motor 70 and the fuel injector 80 are controlled by the ECU 60.

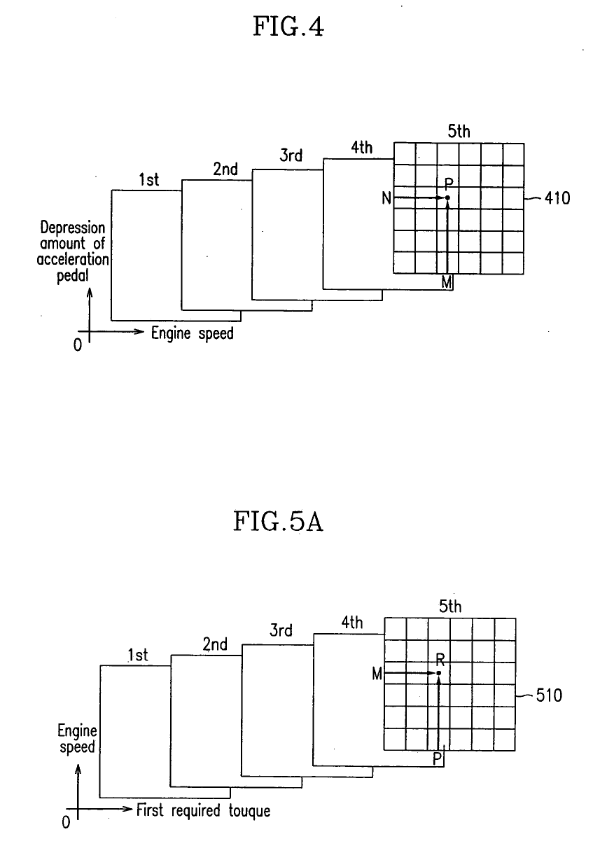

FIG. 4 is a graph showing a first look-up table 410 used for computing the first required torque according to an embodiment of the present invention. The shift range, the depression amount of the acceleration pedal, and the engine speed are applied to the first look-up table 410, and the first required torque is determined. The first predetermined look-up table 410 for the first required torque is stored in the ROM 63 of the ECU 60. For example, as shown in FIG. 4, when the shift range is 5th speed, the depression amount of the acceleration pedal is “N”, and the engine speed is “M”, the first required torque is determined as “P”.

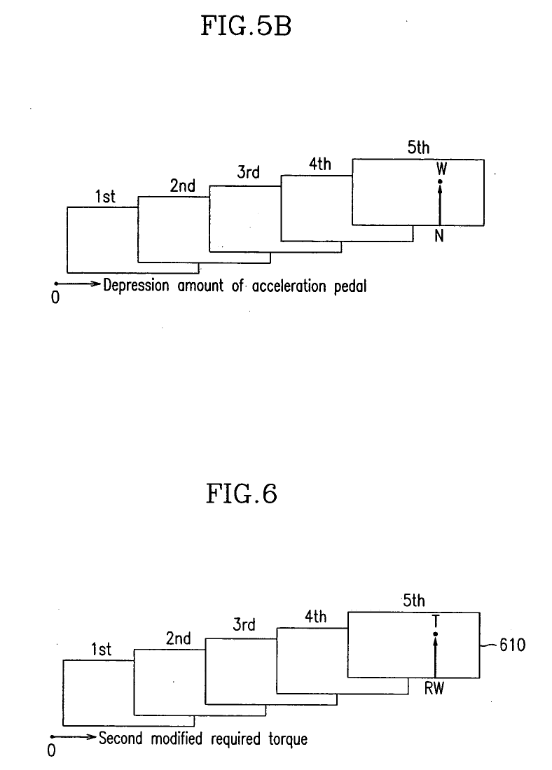

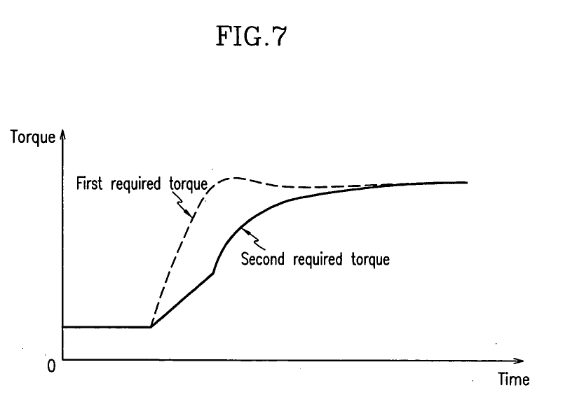

FIG. 5A is a graph showing a second look up-table used for computing the first modified required torque, and FIG. 5B is a graph showing a third look-up table used for computing a weighting for the second modified required torque. The shift range, the first required torque, and the engine speed are applied to the second look-up table for limiting the gradient of the first required torque with respect to time, and the first modified required torque is determined. The second look-up table is 510 for the first modified torque, and is stored in the ROM 63 of the ECU 60.

For example, as shown in FIG. 5A, when the shift range is the 5^{th} speed, the first required torque is “P”, and the engine speed is “M”, the first modified required torque is determined as “R”. The second predetermined look-up table that is representative of the gradient limit function prevents an abrupt shift and a shift jerk caused by the steep increment of the first required torque. If the gradient of the first required torque is more than a predetermined value, the first required torque is modified to have a constant gradient such that the depression amount of the acceleration pedal 50 operated by the driver is not reflected on the first modified required torque.

Accordingly, in order to reflect the depression amount of the acceleration pedal 50, a weighting is computed that utilizes a weight function, of which the output value is determined by applying the shift range and the depression amount of the acceleration pedal to the third predetermined look-up table. The computed weighting is multiplied by the first modified required torque such that a second modified required torque is computed.

For example, as shown in FIG. 5B, when the shift range is the 5^{th} speed and the depression amount of the acceleration pedal is “N”, the weighting is determined as “W” such that the second modified required torque is computed as “RW” by multiplying “W” by the first modified required torque “R”. Preferably, the weighting is proportional to the depression amount of the acceleration pedal 50. Accordingly, when the depression amount of the acceleration pedal 50 increases, the second modified required torque also increases.

FIG. 6 is a graph showing a fourth look-up table 610 used for computing the second required torque according to an embodiment of the present invention. The shift range and the second modified required torque are applied to the fourth predetermined look-up table, and the second required torque is determined. The fourth predetermined look-up table 610 for the second required torque is also stored in the ROM 63 of the ECU 60. For example, as shown in FIG. 6, when the shift range is the 5^{th} speed, the second modified required torque is “RW” and the second required torque is computed as “T”. The fourth predetermined look-up table 610 that is representative of a one-dimensional time delay function is operated as a torque filter. The amount of time delay is computed in accordance with the shift range, and more specifically, the amount of time delay is inversely proportional to the shift range.

Accordingly, in low shift range the fourth predetermined look-up table functions as a stronger torque filter such that shift jerk is prevented, and conversely, in high shift range the fourth predetermined look-up table functions as a weaker torque filter such that the accelerating performance is not deteriorated.

According to the torque control method of the present invention, when the first required torque computed on the basis of the depression amount of the acceleration pedal and the engine speed is modified to the second required torque, a driver's intention is efficiently reflected onto the second required torque, and deterioration of acceleration performance in a high shift range is prevented.

1. A torque control method for controlling a throttle motor on the basis of a required torque of an engine, comprising:
computing a first required torque on the basis of a depression amount of an acceleration pedal and an engine speed; and
computing a second required torque by multiplying an output value of a gradient limit function by an output value of a time delay function;
wherein the output value of the gradient limit function is determined on the basis of the first required torque, an acceleration pedal depression amount, an engine speed, and a shift range, and
wherein the output value of the time delay function is determined on the basis of the shift range.

2. The torque control method of claim 1, wherein the gradient limit function is defined by multiplying:
a basic gradient limit function, of which the output value is determined motor on the basis of the first required torque, the engine speed, and the shift range; and
a weight function, of which the output value is determined motor on the basis of the acceleration pedal depression amount and the shift range.

3. The torque control method of claim 2, wherein the output value of the weight function is proportional to the acceleration pedal depression amount.

4. The torque control method of claim 3, wherein the time delay function is defined as a one-dimensional time delay function, and the output value of the time delay function is determined motor on the basis of the shift range.

5. The torque control method of claim 4, wherein the output value of the time delay function is proportional to the shift range.

6. The torque control method of claim 2, wherein the output value of the basic gradient limit function and the output value of the weight function are determined from a plurality of predetermined look-up tables.

7. The torque control method of claim 4, wherein the output value of the time delay function is determined from a plurality of predetermined look-up tables.
